(19) United States
(12) Patent Application Publication
(10) Pub. No.: US 2017/0237564 A1
(43) Pub. Date: Aug. 17, 2017

(54) TWO-PARTS-ARE-ONE PASSWORD

(71) Applicants: Eiji WATANABE, Yokohama-shi (JP); METEORA SYSTEM CO., LTD., Yokohama-shi (JP)

(72) Inventors: Eiji WATANABE, Yokohama-shi (JP); Yoshihiro SEKIGUCHI, Tokyo (JP)

(21) Appl. No.: 15/406,782

(22) Filed: Jan. 16, 2017

Related U.S. Application Data
(63) Continuation of application No. PCT/JP2014/070142, filed on Jul. 18, 2014.

(51) Int. Cl. H04L 9/32; H04L 29/06; H04L 9/06; H04L 9/14

(52) U.S. Cl. CPC H04L 9/3226; H04L 9/14; H04L 63/083; H04L 9/0643; H04L 9/0625; H04L 63/0853; G06F 17/11

(57) ABSTRACT

The event of [Probability that the two-parts-become-one]=1.0 is “Two-parts-are-one password”. The event of probability<<1.0 is “Two-parts-are-not-one password”. Even if a password of the service side leaks, it is harmless. The maintenance cost of the password is unnecessary. There exists the decomposition point of responsibility within “Two-parts-are-one password” itself so that it becomes disadvantageous to bring up a lawsuit. No password file and no password backup required in an authentication server segment. The core that has produced these innovative effects is the implementation of Split Knowledge and Dual Control of an active key data; it satisfies PCI DSS version 1.2.1 for the first time in the world.

### CROSS-REFERENCES TO RELATED APPLICATIONS

This Application claims the benefit of priority and is a Continuation application of the prior International Patent Application No. PCT/JP2014/070142, with an international filing date of Jul. 18, 2014, which designated the United States, the entire disclosures of all applications are expressly incorporated by reference in their entirety herein.

### BACKGROUND OF THE INVENTION

1. Field of the Invention

IT concerns “TWO-PARTS-ARE-ONE PASSWORD” system that wipes out the hotbed of crime around the password and its login method. It concerns also a means for implementing a password to break away from the traditional login method.

2. Description of Related Art

### 1. Traditional Password Features

The common sense of IT is “one password”. There is no password as to “one by two” or “two parts are one”. Since “Password is one”, a service provider requests registration of this password. The registered password is mere data. The incident of attacking a service side aiming at this data is large in scale and still happens somewhere.

The traditional login mechanism seems to operate two passwords using a hash function; and 10 and 20 in FIG. 1 are “≠” from each other.

[Mathematics 1]

Cj (the registered hash value)≠P(a password at login) (1)

However, even in Hash method, “Password is one”;

[Mathematics 2]

Cj (a hash value in a password file)=Ci (a password at login) (2)

h(P)=h(P)

[Mathematics 2] is a tautology as you see 30 in FIG. 1. Using this tautology, the service provider side attempts access restriction. Even if you provide a second password, it will not improve the tautology.

Since the service provider side imposes access restrictions by this tautology, another means of arming is required against cyberattack, which is a considerable expense. It is a cost that the IT industry claims as a matter of course to other industries and it is a revenue source of the IT industry, which is invisible to the user. The service provider who introduced the IT carries the risk of litigation. If there was such a login method easy-to-implement (stateless) that does not depend on tautology, it could not avoid restructuring the IT industry.

2. Lack of Decomposition Point of Responsibility P There is a hidden incident not appearing in the table. Since “password is one”, a user and the service side share a password. Because of shared information, the service side will be responsible for it. Because of the tautology, there is no Presence of decomposition point of responsibility between the two parties, so when a lawsuit is brought up, the defendant cannot disprove a claim for compensation. This is the trigger for the temptation to present an outright litigation amount. The service provider has no way to continue business in addition to paying “compensation”.

Since the incident in 2011, Sony Enterprise has scattered roughly $10 billion litigation charges. Despite this reality, there is no logic other than tautological access restrictions at this moment.

### 3. MITB Attack Which Becomes Full-Scale [See Non-Patent Document]

The damage of illegal remittances is increasing recently. Malware that breaks into an online banking PC works only when a person accesses a specific page; tampering the display of the Web page, as soon as the ID and password are entered, it immediately changes the remittance account. It was named MITB “Man-in-the-Browser” attack. We know of such a virus that specializes in payment cards as phishing. Both are said to have no technical measures. [See non-patent document]

As the virus does, it is difficult for both browser users and service side administrators to figure out. The current login method targeted by viruses has the following characteristics;

1) To restrict access by the password tautology,

2) Access right is given to this tautology,

3) Password input interface must be provided on the concerned application screen. This is a restriction to usage of the password in order to protect service providers who are armed with the tautology.

With these three factors MITB and phishing will be completed in the browser. Having these three factors is a feature of the current login method.

As long as a virus is attached to the browser, the virus completes tampering of the page, rewriting of the data, and transmission work.

Let's see the image diagram of Google (registered trademark) 2 step verification (see FIG. 2). Input the one-time password in addition to the usual user name and password on the concerned screen. Although it is one time, what you are doing is to restrict access by tautology, so again, “password is one”.

Even if all of these conventional technologies are mobilized, “Password is one”; access restriction by tautology does not change.

### PRIOR ART DOCUMENT

### Patent Literature

PCT/JP2011/005830“Management-Free Key System”

PCT/JP2013/68181 “Asymmetric password, Asymmetric authentication code, Asymmetric verification code”

### Non-Patent Literature

MITB attack to become serious:

http://www.atmarkit.co.jp/ait/articles/1404/04/news110.html

Payment Card Industry (PCI) Data Security Standard: Requirements and Security Assessment Procedures Version 1.2.1 July 2009

### BRIEF SUMMARY OF THE INVENTION

As long as the virus is attached to the browser [0009], it deprives the access authority of the password, completes tampering of the page, rewriting of the data, and it follows transmission works. It is necessary in the concerned screen to separate the input interface of the transaction data from the input interface of the password; this is a security requirement.

In connection with the above challenge (requirement), there is already such a MITB countermeasure that conducts transaction confirmation before settlement of remittance; IBM (registered trademark) “ZTIC” and VASCO Data Security (registered trademark) “DIGIPASS (registered trademark)”. These existing means have drawbacks; it functions as an external attachment of the current login mechanisms and does not function inside the login mechanism. It does not target general users. [See non-patent document]

### [Means-1]

It is easy for the virus to be attached to the browser and it is easy for the virus to monitor a given screen of the browser, and it is easy for the virus to monitor the concerned screen of the terminal attached to the arbitrary terminal. Therefore, “TWO-PARTS-ARE-ONE PASSWORD” system with a login method separating the password input interface from the concerned screen comprising:
an authentication server that prepares two cipher (code) groups mutually different from each other with overwhelming probability, that is, creates codes Ci and Cj of [Mathematics 3], and that makes possible for a user and the service provider to use the codes Ci and Cj as the passwords Ci and Cj;

[Mathematics 3]

Code Cj≠Code Cj (3)
the authentication server that has a function of trying to decrypt the cipher of [Mathematics 3] only when both codes Ci and Cj gather together; thereby,
to remove usage restrictions on passwords that they must be entered on a given screen on the condition to decrypt the cipher only when both codes Ci and Cj gather together as described above,
a portable terminal or portable memory carried, therein either one of the codes Ci and Cj of [Mathematics 3] is recorded as a password.

### [Means-2]

“TWO-PARTS-ARE-ONE PASSWORD” system according to claim 1, wherein a communication session sending one of the passwords Ci and Cj of the mobile terminal or portable memory to the authentication server shall take over a session ID (random number carried by the packet) of the concerned application.

### [Means-3]

The authentication server according to claim 1 comprising implementation of Split Knowledge of a key, thereby creation of the passwords Ci and Cj; specifically speaking, the implementation of Split Knowledge of a key is such that:
it has two one-way functions Y₁( ) and Y₂( ) and calculates the following [Mathematics 4] of a key data K and sets the output value to the values of the passwords Ci and Cj of the [Mathematics 3]; and

[Mathematics 4]

Ci=Y₁(K) (4)

Cj=Y₂(K) (5)
it deletes the key data K from the system immediately after recording the passwords Ci and Cj in the mobile terminal or the mobile memory and the memory on the service server side, so that the key data K cannot be obtained anymore. Note that Split Knowledge of a key is a term derived from PCIDSS (non-patent document).

### [Means-4]

The authentication server according to claim 1 comprising:
Procedure to use trapdoor of two one-way functions Y₁( ) and Y₂( ) according to claim 3,
Probability Calculation Means [Mathematics 7] calculating [Probability that two-parts-become-one] only when both codes Ci and Cj of [Mathematics 3] gather together,

[Mathematics 7]

Y₁⁻¹(Ci)=Y₂⁻¹(Cj)=K-->[Probability calculation that the two-parts-become-one]

[Probability that the two-parts-become-one]=1.0-->[Authentication notice]

[Probability that the two-parts-become-one]<<1.0-->[Error notice]

that is, in case [Probability TWO-PARTS-ARE-ONE]=1.0, Authentication notice is returned to both a user side and the service server side, and in case [Probability TWO-PARTS-ARE-ONE]<<1.0, Error notice is returned to the both. Note that Y₁⁻¹(Ci) AND Y₂⁻¹(Cj) expresses a trap door of one-way functions Y₁( ) and Y₂( ).

### BRIEF DESCRIPTION OF THE DRAWINGS

FIG. 1 is a diagram for explaining a password that seems two passwords existing as Cj=h(P)≠P.

FIG. 2 shows an image of two steps verification of Google (registered trademark).

FIG. 3 is a diagram for explaining an implementation of TWO-PARTS-ARE-ONE PASSWORD.

FIG. 4 is a diagram for explaining countermeasures against MITB implemented inside the login mechanism.

FIG. 5 is a framework of “Split Knowledge of a key” based on Separation of duties

FIG. 6 is a framework of “Split Knowledge of a key” during operation.

FIG. 7 is an implementation form of Split Knowledge of a key to the route to take over session ID.

FIG. 8 is an implementation form of [Mathematics 7] to the route to take over session ID.

FIG. 9A is a cryptographic topology of the MFK.

FIG. 9B is a cryptographic topology in commonsense.

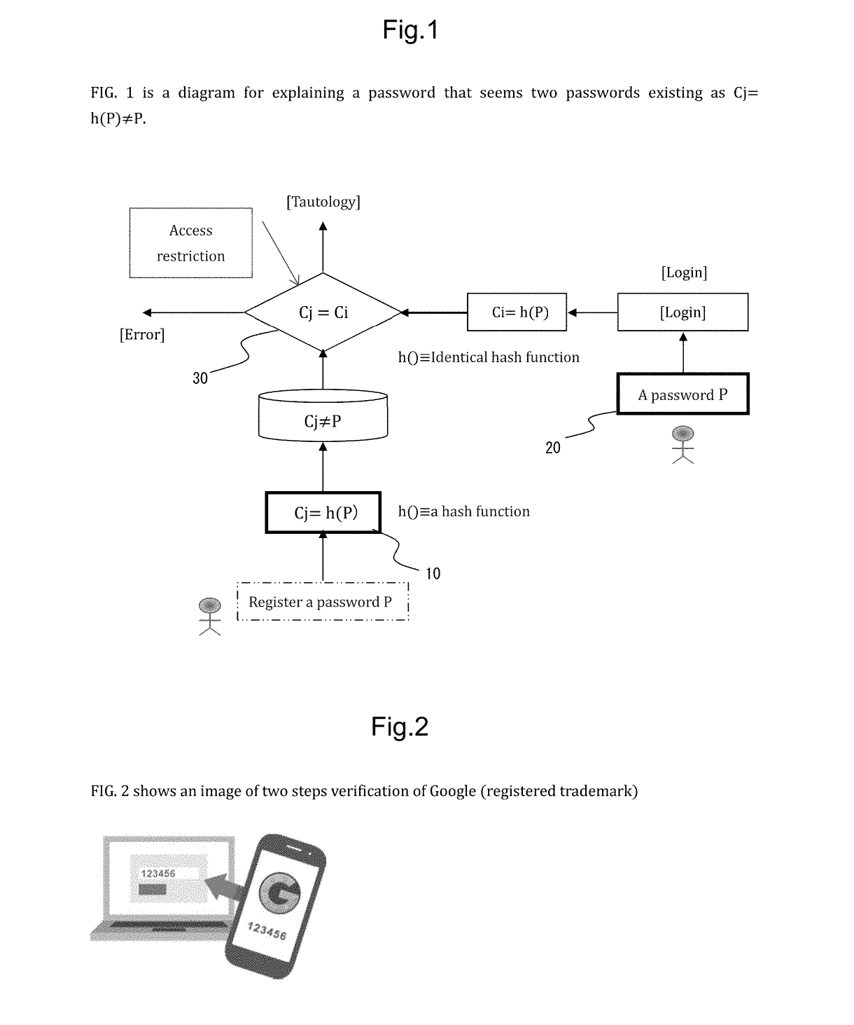

### DETAILED DESCRIPTION OF THE INVENTION

### [Means 1 and Means 2 and the Implementation Example]

### [Login Method Described by Means 1]

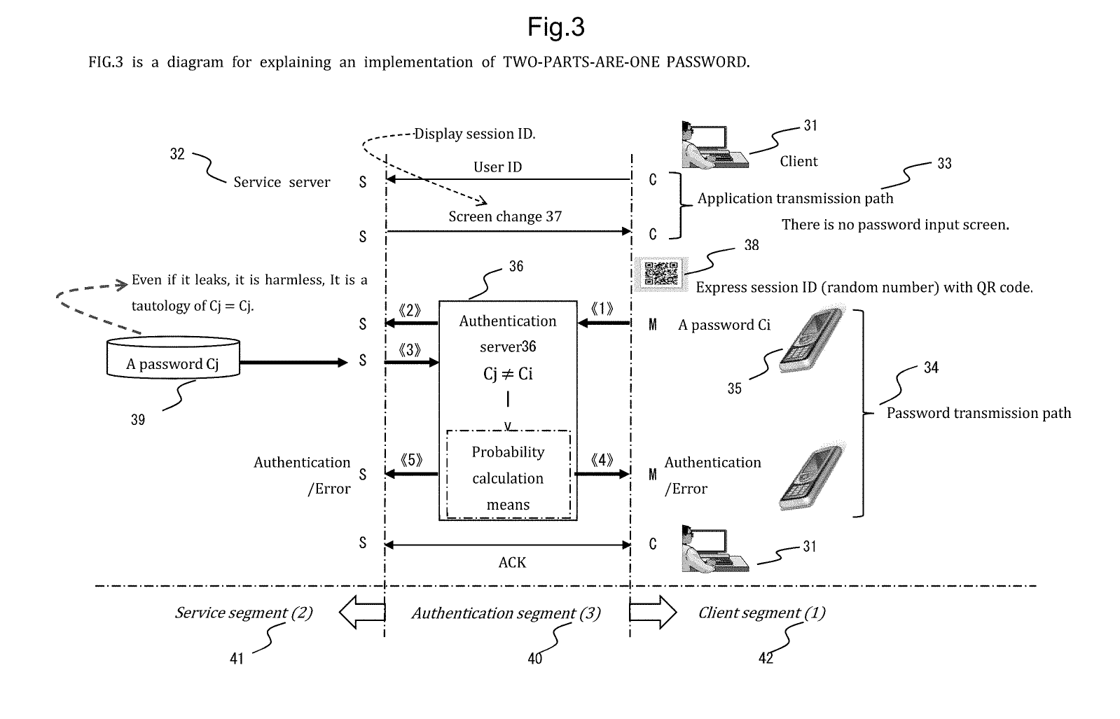

It is easy for the virus to be attached to the browser and it is easy for the virus to monitor a given screen of the browser, and it is easy for the virus to monitor the concerned screen of the terminal after the virus is attached to the terminal, Therefore, it is urgent to establish a login method that separates the password input interface from the screen of the application. FIG. 3 illustrates a login method in which the password does not pass through the communication session of the browser or the communication session of an arbitrary terminal.

The login method is divided into three network segments as viewed from a large perspective,PC segment (1) 42, service server segment (2) 41, and authentication segment (3) 40.

The main components of FIG. 3 are as follows; Symbol S represents the service server 32, PC represents the personal computer 31, and symbol M represents the smartphone 35. There are communication sessions 33 of the application that terminates in the personal computer 31 and the service server 32, and a communication session 34 of the password that terminates in the mobile terminal 35 and the authentication server 36, as well as two codes Ci and Cj of the [Mathematics 3].

[Mathematics 3]

Code Cj≠Code Cj (3)

In the [Mathematics 3], there is a scenario such that the code Ci is held in the portable terminal or the portable memory and the service server has the code Cj, where both use the codes Ci and Cj as the password.

The communication session of the password in FIG. 3 includes a route <<1>> between the password Ci of the smartphone 35 and the authentication server 36, a route <<3>> between the password Cj of the service server 32 and the authentication server 36, and a route <<2>> in order for matching the timings of the route <<1>> and the route <<3>>, and at least includes the routes <<1>>, <<2>> and <<3>>.

### [There is No Password-Input Screen at Login]

When a person inputs the user ID to the personal computer 31, the screen changes 37 as usually, however, persons never find the password-input screen there. Note that the user ID may depend on the card insertion.

Instead of the current password-input screen, the implementation of the patent application converts to the screen 37 displaying the session ID of the communication session 33 of the application; this display format is QR code (registered trademark) 38.

### [Session ID Described in Means 2]

Instead of the password-input screen, the QR code 38 appears. The smartphone 35 reads the QR code 38. It is a manner of about 1 second. The session ID is a random number carried by the packet.

### [Password Communication Session]

Thus the smartphone takes over the session ID, the input of the codes Ci and Cj of [3] is realized in the communication session of a password independent of the communication session of the browser. The communication session is a transmission path between the same ports. The smartphone 35 having received the session ID with the QR code 38 transmits the password Ci to the authentication server 36 with the route <<1>>.

The Route <<1>> of the password Ci is not a transmission path of the browser but the transmission path with “removal of usage restrictions on passwords that they must be entered on a given screen” according to claim 1.

Since the two communication sessions are independent, it is necessary for “the communication session for sending the password Ci of the portable terminal or portable memory to the authentication server to take over the session ID of the application”. This is the means 2.

### [Security Achieved by Means 1 and 2]

That effect wipes out the hotbed of crime around the password. It is as follows.

1. Resistance Against the Password Run-Off Incident_Turn Off the Risk of the Service Side_

The smartphone 35 has a password Ci while the service server 32 has another password Cj. The password Cj of the service server 32 is a target of a cyberattack. Let us assume that this Cj leaked out and that any smartphone 35 had it and entered the authentication server 36 via the route <<1>>. Then,

a password Cj=a password Cj (2)

the authentication server 36 verifies the equation (2). This is found a tautology, the same with [Mathematics2], and so the authentication server 36 returns an error to the tautology of [Mathematics 2]. (The code Cj and Ci in [Mathematics 3] is different from the tautology (2)).

We notice that the return of the error is that the logic of the “two codes Ci and Cj” itself returns an error. Even if the smartphone is forged, the authentication server 36 returns an error.

2. Presence of Decomposition Point of Responsibility_Eliminate Litigation Risk_

The authentication server 36 returns an error to the tautology (2). Tautology (2) does not originally have a decomposition point of responsibility.

On the other hand, [Mathematics 3] is by itself the logic of the decomposition point of responsibility. By two parties having the two codes Ci and Cj as passwords respectively, at this moment of having them, the responsibilities of the two parties are resolved. And Service side litigation risk disappears.

3. There is No Password File in the Authentication Segment (3)_Cost Reduction of the Service Provider_

The service server 32 is not damaged even if the password Cj leaks out. That is equivalent to not having a password file.

The authentication server is simply a device that only handles the flow of data. Therefore, the cost of implementation and operation on the service provider side is extremely reduced.

4. Include Transaction Confirmation Inside Login_Method Measure Against Full MITB Attack_

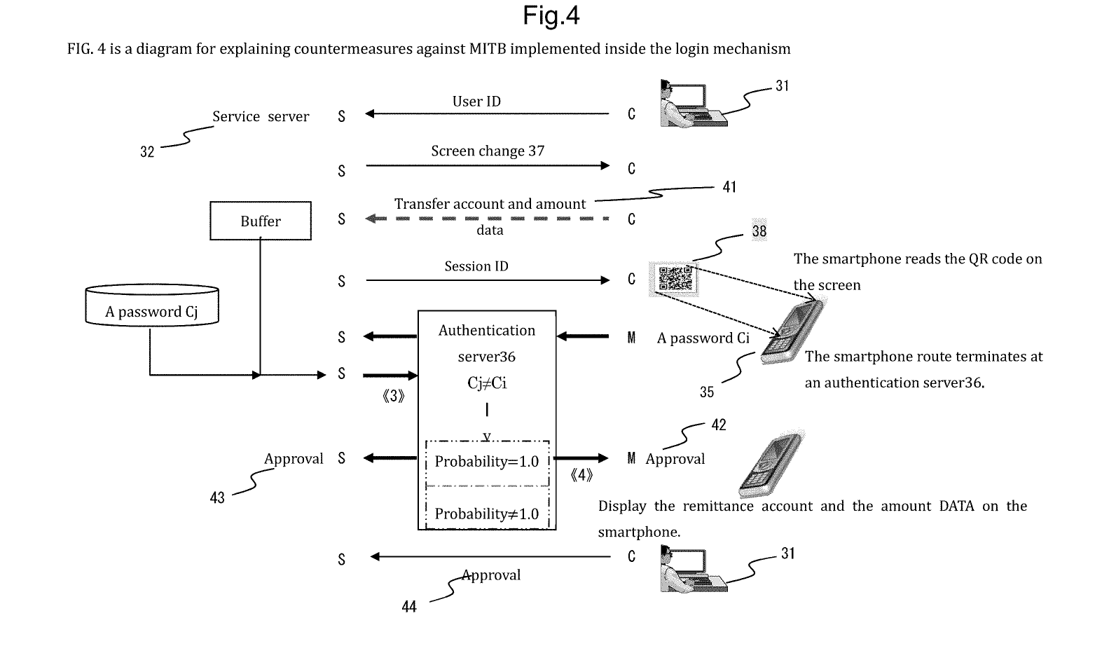

As stated in means 2, the effect “that the communication session with the password Ci inherited the session ID (random number) carried by the packet of the communication session of the application” is shown in FIG. 4: this is a measure against MITB attack. That is, when the service server 32 receives the remittance account and the amount data 41, it feeds back the remittance account and the amount data 41 to the smartphone 35, and causes the user to confirm the transaction.

The screen change 37 at this time is a screen for inputting the remittance account and the amount of money. When the service server 32 receives the remittance account and the monetary amount data 41, it gives the session ID to the PC (application) 31, and simultaneously stores the remittance account and the amount data 41 in the buffer.

The smartphone 35 takes over the session ID 38. Thereafter, the service server 32 notifies the user of the transaction data stored in the buffer via the routes <<3>> and <<4>>. Consequently, it notifies the user of transaction data as an event of authentications 42 and 43.

The remittance account and amount data are displayed on the smartphone. When the user performs the confirmation operation on the PC, the approval notice 44 reaches the service server 32.

In this way, transaction confirmation can be included in the login method using the routes <<1>>, <<2>>, <<3>>, <<4>> and <<5>>. The current countermeasure such as IBM (registered trademark) “ZTIC” and VASCO Data Security (registered trademark) “DIGIPASS (registered trademark)” is a means of externalizing the login method, however, the “communication session with password Ci” of the present application is included in the login method.

### [Implementation Embodiment of Means 3 and Means 4]

The authentication server of the invention originates in “Split Knowledge of a key” required by PCI DSS version 1.2.1. The means 3 and the means 4 are means for enabling the implementation of the “Split Knowledge of a key” without any contradiction.

### 1. Split Knowledge of a Key Required by PCI DSS

Firstly, “Split Knowledge of a key” will be explained. “Split Knowledge of a key” is a term derived from PCI DSS (see [Non-Patent Document]).

Industry Organization PCI SSC^{(Note 1)} required such risk management that implements Split Knowledge of an active key during operation into two parts and that the key function must be restored if the split two parts are aligned together. This was of PCIDSS version 1.2.1 published in June 2009. It is evident in the original text below;

PCI DSS v1.2.1 Requirements 3.6.6 “Split knowledge and establishment of dual control of cryptographic keys”

Testing Procedures v1.2.1 “Verify that key management procedures are implemented to require split knowledge and dual control of keys”

Note 1: PCI SSC; Payment Card Industry Security Standards Council

The requirement was enough to puzzle the IT industry, that is, really because there is no one who can do consultation such as splitting an active key into the two parts or more.

Looking at this reality, the PCI SSC made the following considerations; even if it is not as stated in the requirement, if it is judged that risk analysis has been carried out and countermeasures have been taken, it is to be PCI DSS compliant as “Compensating Controls”. Eventually, the PCI SSC abandoned the implementation of requirement 3.6.6 of version 1.2.1 and revised to version 2.0. (October 2010)

Requirement 3.6.6 of the revised version 2.0 is not “Split Knowledge of an active key”, but the split knowledge of a key performed by manual operation based on the separation of duties. It is evident in the original text below; “If manual clear-text cryptographic key management operations are used, these operations must be managed using split knowledge and dual control”.

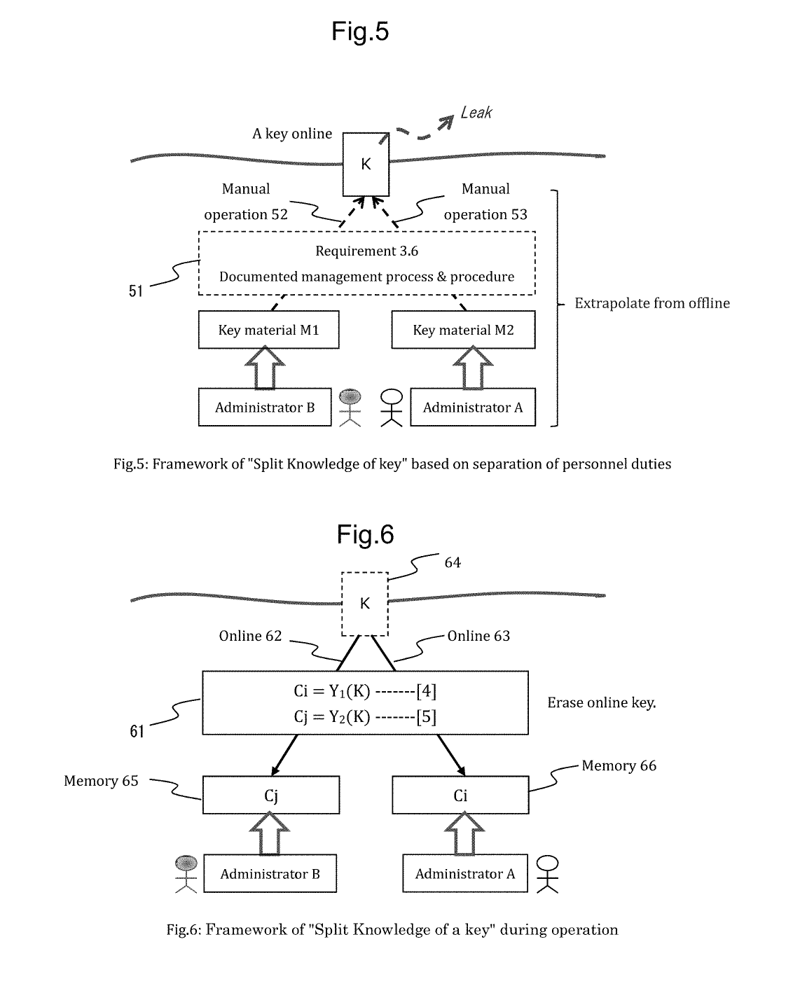

This entity is not dual control of a cryptographic key but “key synthesis” based on the separation of duties. It is shown in FIG. 5.

For example, synthesize key materials owned by two managers and set them offline to online; In FIG. 5, the requirement 3.6 was expressed as “documented management process and procedure” 51. It is represented by thick dotted lines 52 and 53 so that it is synthesized with human hands.

As mentioned above, the “Split Knowledge of an active key” under operation is still under silent treatment in 2014.

### 2. Means of Implementation of Split Knowledge of a Key

It is difficult to imagine implementing Split Knowledge of an active key, based on the “key synthesis” framework of FIG. 5. However, if the wisdom of information science is added to it, the form of its implementation comes out.

Firstly, 51 “documented management process and procedure” in FIG. 5 is replaced with 61 “two one-way functions Y₁( ) and Y₂( )” in FIG. 6. Secondly, the arrows of “manual operation” 52 and 53 in FIG. 5 are reversed and replaced with “online” 62 and 63 in FIG. 6. This FIG. 6 is a “Split Knowledge of a key during operation” framework. The introduction of two one-way functions Y₁( ) and Y₂( ) has the effect of subtracting a supplementary line to the geometry of FIG. 5.

In FIG. 6, a key K 64 is online referred to by any application. Enter the key K 64 into the two functions Y₁( ) and Y₂( );

[Mathematics 4]

Ci=Y₁(K) [4]

Cj=Y₂(K) [4]

Calculate [Mathematics 4]; the key K 64 changes to code Ci and code Cj, and is recorded in memories 65 and 66, and administrators A and B possess each of them.

The key K 64 has changed into code Ci and code Cj. In order to say that the two codes are passwords (Split Knowledge), it is necessary to delete the key K 64 from the system. Then, with respect to outputs of the two one-way functions, the administrators A and B cannot know the code of the other party. Therefore, [Mathematics 3] described in Means 1 is established with overwhelming probability;

[Mathematics 3]

Code Cj≠Code Cj (3)

This means that each other's code is “unknown”, and it is not a definition, but an effect of the overwhelming property of probability. To ensure this overwhelming probability, make the bit length of the codes Ci and Cj be 128 bits or more.

The timing to erase the key K 64 from the on-line is when the codes Ci and Cj are recorded in the memories 65 and 66; only the codes Ci and Cj remain in the system.

In Split Knowledge of an active key, the function to erase the key K 64 from the online is represented by the symbol Make-past ( );

[Mathematics 5]

K=Make-past(K)

This equation expresses that “an erased key K exists in the past world”; in short, it was erased but “exists in the past world”.

The above [Mathematics 3], [Mathematics 4] and [Mathematics 5] are mathematical scientific definitions concerning Split Knowledge of an active key.

### 3. Embodiment of Implementation of Split Knowledge of a Key

The embodiment of [Mathematics 3], [Mathematics 4] and [Mathematics 5] is actually Password transmission path 34 in FIG. 3. That is, the authentication server according to Means 1 is provided with “Split Knowledge of a key” during operation., and that embodiment of implementation is expressed by the routes <<1>>, <<2>>, <<3>>, <<4>> and <<5>> in FIG. 3.

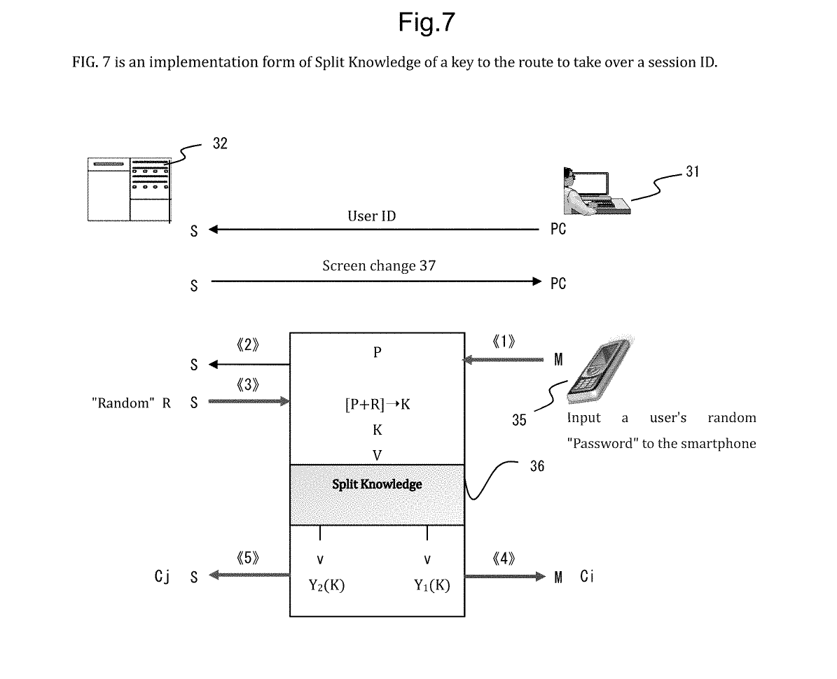

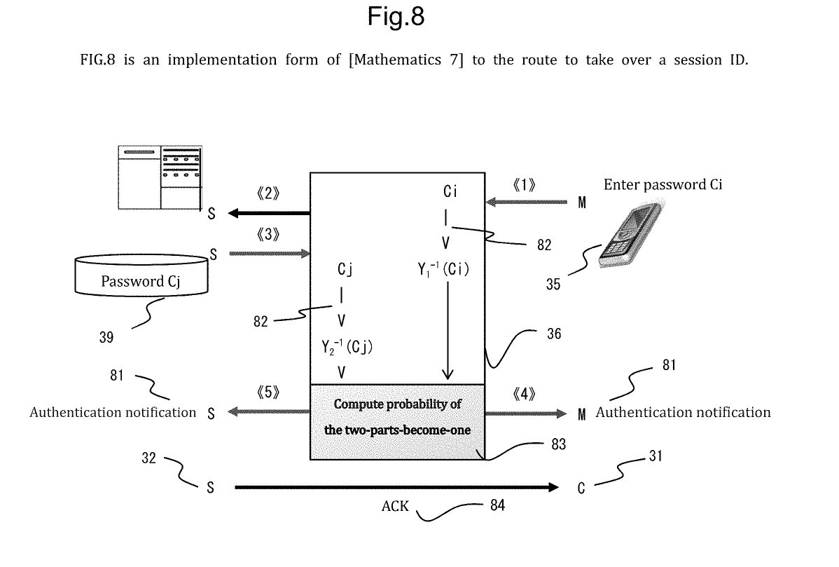

FIG. 7 and FIG. 8 shows the implementation form; FIG. 7 expresses Split Knowledge of a key data K described in Means 3 and FIG. 8 expresses Probability calculation means described in Means 4.

A trap door composed of the two one-way functions is used for the probability calculation means. We have not claims of the means for realizing the one-way functions themselves. This is because there is no need to claim since it is a means to be implemented, in any means, in the communication session 34 of password independent of the communication session 33 of the application of FIG. 3. The password communication session 34 is the result of implementing the login method (means 1) and the session ID (means 2). Note that the implementation method of the functions is described in [Document 2].

### [Split Knowledge of a Key Data K≡Initialization]

In FIG. 7, a user's random “Password” is sent to the authentication server via the route <<1>>, and the service server sends a relatively long random number “random” to the authentication server via the route <<3>>.

[Mathematics 6]

K=“Password”+“Random” [6]

The authentication server calculates the expression [6]. This K is of the key data. This key data K is given to the Split Knowledge 36 [Mathematics 4] and the codes Ci and Cj are stored in the memories 35 and 39 in FIG. 3 via the path <<4>> and the path <<5>>. The left is called initialization. Immediately after the initialization, the key data K is deleted.

[Mathematics 5]

K=Make-past(K)

As described in [0057], this equation means that the key data K was “hidden in the past world”, so “exists in the past world”. There is no provision for saving “Password” and the key data K anywhere in the system. However, as far as the key data is concerned, it “exists in the past world”. In this figure, the function of the session ID is omitted.

The above is a disclosure of such content that “Password” and its key data K changed to passwords Ci and Cj.

### [Use of the Key Data K Existing in the Past World]

The key data K “exists in the past world”. Procedure for its use is means 4; “it provides with procedure to use the trapdoor for reproducing the key data K from the passwords Ci and Cj”. The procedure is shown in FIG. 8. The trap door means “a hidden door for obtaining an inverse function value” of the two one-way functions Y₁(K) and Y₂(K).

The authentication server of the means 1 comprises a procedure of using the trapdoor of two one-way functions Y₁( ) and Y₂( ) described in the means 3. The form of this procedure is shown below.

FIG. 8 shows a state in which the password Ci of the smartphone 35 is sent to the authentication server 36 via the route <<1>>, and similarly, the password Cj of the DB 39 of the service server 32 is sent to the authentication server 36 via the route <<3>>. When the two gathered together, only at that time, they enter through path of each trap door 82 (downward arrow) to calculate “the probability that two-parts-become-one ”.

We denote inverse functions of the two one-way functions Y₁(K) and Y₂(K) as Y₁(Ci)⁻¹ and Y₂⁻¹(Cj); they are functions which should not exist in one-way functions, so called a trap door but they (two parts) compose a trap door. [Mathematics 7] shows “Probability calculation means 83 that the two-parts-become-one” through path of the trap door 82 (downward arrow).

[Mathematics 7]

Y₁(Ci)⁻¹=Y₂⁻¹(Cj)=K-->[Probability calculation that two-parts become one]

[Probability that two-parts-become-one]=1.0-->[Authentication notification]

[Probability that two-parts-become-one]<<1.0-->[Error notification]

When the two passwords Ci and Cj gathered together, the authentication server works that the two codes enter through path of each trap door to calculates Y₁(Ci)⁻¹=Y₂⁻¹(Cj). The use of path of the trap door is not possible unconditionally but only with the two codes gathering together. The “two-parts-become-one” is represented by the part of [=K] 83 in the following equation [7]:

Y₁(Ci)⁻¹=Y₂⁻¹(Cj)=K -->[7]

When such the probability is=1.0 that the inverse functions Y₁(Ci)⁻¹ and Y₂⁻¹(Cj) becomes the key date K, the means 83 returns an authentication notice to both the user side and the service server, or otherwise an error notice to the both when the probability<<1.0.

In the traditional tautology access restriction, two passwords are originally one according to [Mathematics 2];

h(P)=h(P) (2)

By cracking the leaked hashed password and throwing P in the equation (2), this access restriction (2) is tricked. However, the password run-off incident of this application [0032] is also expressed by the same equation (2) as follows;

a password Cj=a password Cj (2)

Despite of the above, the calculation [7] of [Mathematics 7] puts the passwords of (2) into the handling of [Probability that two-parts-become-one]<<1.0. And an error notice is to be returned.

As to [=K] 83 in the calculation [7], assumed that bit length of the passwords Ci and Cj is 128 bits, and it produces the vast number of combinations of passwords Ci and Cj, say [2¹²⁸*2¹²⁸]. Among them, <1> The number of [2¹²⁸*2¹²⁸−1] becomes an error; that is, the number of [2¹²⁸*2¹²⁸−1] of combinations of codes Ci and Cj could not use the inverse functions Y₁(Ci)⁻¹ and Y₂⁻¹(Cj); so that it means the nature of the one-way function is always hedged (guaranteed).

<2> Only the pair of codes Ci and Cj has succeeded in using the trap door. Those carrying this passwords Ci and Cj become the authenticated.

Thereafter, when the authentication server 36 receives the authentication notification 81, the service server 32 sends the ACK 84 to the PC 31.

There are no claims as to the one-way function itself. Regarding that reference, we turned to [contrast with the prior art] described later.

### [Effects on Business Model]

1. Presence of decomposition point of responsibility . . . Only carrying Two-parts-are-one password provides the decomposition point of responsibility between a user and the service provider.
2. Eliminate litigation risk . . . Appealing to the proof-of-existence of decomposition point of responsibility makes the lawsuit disadvantageous.
3. Antivirus . . . There is no password input interface in the business terminal; therefore virus activity or any attack is restricted.
4. No maintenance cost required . . . The maintenance cost of the password is unnecessary.
5. No password backup required . . . It is possible to create a chain of the initialization [0062] thereby to input a one-time password to the authentication server.
6. Switching time when system is down . . . The authentication server is simply a device that is processing data flow, that is, the switching time is short so much as there is no DB.
7. Backdoor to communication platform . . . Even with backdoors such as “HUAWEI”, the backdoor cannot disable Dual Control by means of passwords Ci and Cj.
8. No leak information . . . The ID and/or password of the data center or cloud administrator may be leaked or misused in any kind of incident. For example, a subcontracting SE may also have a password; in the case without the password the development work stops, and so let the headquarter staff have one of passwords Ci and Cj and let the subcontracting SE have another, then, It becomes difficult for two people to be involved in the incident.
9. Password innovation business . . . Innovate the current login method.

### Document 2

[Contrast with the Prior Art]

As seen in the article of [0043], the IT industry keeps shunning “Split Knowledge of an active key” that PCI DSS required. It is difficult to imagine implementing Split Knowledge of a key. However, according to the disclosure of [0052], with the hint of FIG. 5 as a hint, the solution and embodiment appears.

### [Cryptographic Split and Use of the Key Contradict Each Other]

In other words, Split Knowledge of an active key has been found to be implemented with two one-way functions Y₁( ) and Y₂( ), the aim of which is to cryptographically split the key data K by the two one-way functions so as to be able to use it. By using PCIDSS terminology, the purpose is “to use the key under Dual Control”.

Due to the nature of the one-way function, its Split and Use of a key contradict each other. That is, there is no such thing to be done that the inverse function value Y₁(Ci)⁻¹ of one-way function Y₁( ) is uniquely determined. Therefore, Split Knowledge of an active key and its Use under Dual control should contradict each other. This contradiction was sufficient for “to puzzle the IT industry”. This is the cause of the Compensating Control's turn.

There is a mathematics that saved the contradiction between its split and use. That is [Probability calculation that the two-parts-become-one] [7] of [Mathematics 7]. According to which, the number [2¹²⁸*2¹²⁸−1] of combinations of codes Ci and Cj could not use the inverse function Y₁(Ci)⁻¹ and Y₂⁻¹(Cj); in other words, the nature of the one-way function had been hedged. We have seen realization here such as to eliminate contradiction between Split Knowledge of an active key and Use under Double Control.

Although the above-probability calculating means [7] is included in claim 4, it does not claim cryptographic means making the one-way function itself. For, the probability calculation means [7] has sufficient power to relieve the “IT industry puzzle”. Probability calculation means [7] which solves the contradiction of the one-way function and the inverse function is such novelty as to contribute to PCIDSS.

[Contrast with Prior Application PCT/JP2011/005830]

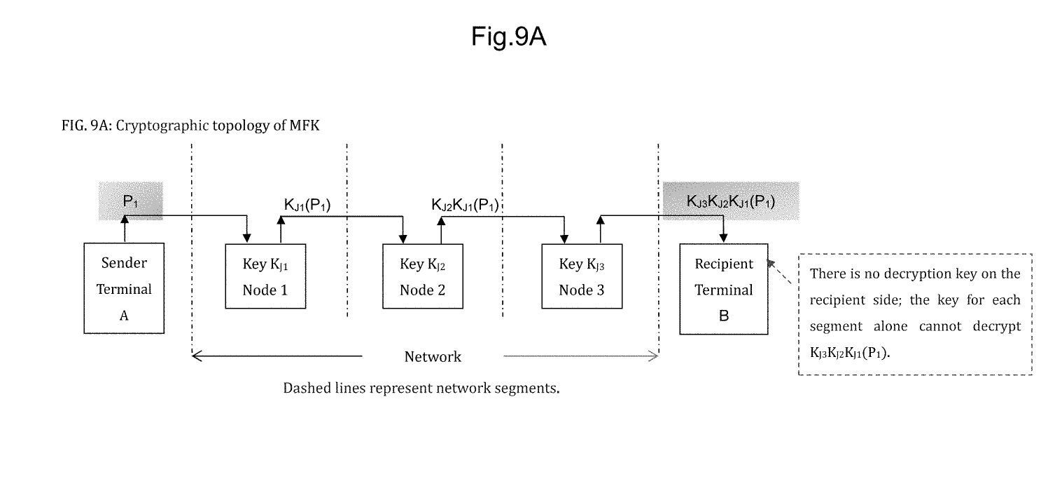

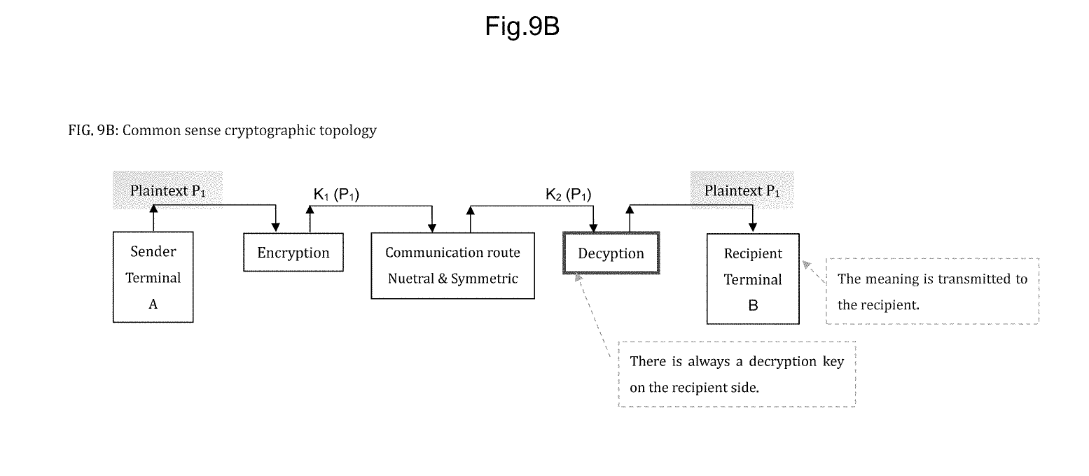

The prior application, “Management-Free-Key System” (refer to MFK), is an abnormal network. “There is no decryption key on the recipient side”. The cryptographic communication has common sense with accompanying decryption key; absence of decryption key preparation is utterly useless substitute, meaningless to the recipient. Decryption key or decryption means must be provided for the recipient side, whether referring to ONION or not. If there is no decryption key, nobody pays Tor (Tor, The Onion Router). However, Tor is under practical use with decryption keys. Comparison between common sense and MFK is illustrated in FIG. 9A and FIG. 9B.

From the viewpoint of the receiver, the fact that the decryption key does not exist on the receiver side is that the received cipher is equal to the output of the one-way function. The network of the prior application is easily implemented in one server by virtualization technology, and so MFK has been useful for implementation of this application, but implementation of this application might be possible by other means, if it can overcome the “the contradiction of Split and Use”. Therefore, we do not claim cryptographic means of one-way functions and the inverse functions.

Note that, this invention is not limited to the above-mentioned embodiments. Although it is to those skilled in the art, the following are disclosed as the one embodiment of this invention.
Mutually substitutable members, configurations, etc. disclosed in the embodiment can be used with their combination altered appropriately.
Although not disclosed in the embodiment, members, configurations, etc. that belong to the known technology and can be substituted with the members, the configurations, etc. disclosed in the embodiment can be appropriately substituted or are used by altering their combination.
Although not disclosed in the embodiment, members, configurations, etc. that those skilled in the art can consider as substitutions of the members, the configurations, etc. disclosed in the embodiment are substituted with the above mentioned appropriately or are used by altering its combination.

While the invention has been particularly shown and described with respect to preferred embodiments thereof, it should be understood by those skilled in the art that the foregoing and other changes in form and detail may be made therein without departing from the sprit and scope of the invention as defined in the appended claims.

What is claimed is:

1. A two-parts-are-one password system using Split Knowledge and Dual Control of a key data and provided with a network system implementing such a login method as separates a password input interface from a given screen which logs in to a service server related to an applied work through the given screen of an arbitrary terminal comprising:
the network system includes a client segment (1) to which the arbitrary terminal belongs, a service segment (2) to which the service server belongs, and an authentication segment (3) to which the authentication server belongs.
wherein the arbitrary terminal of the network system has a function of acquiring a session ID of a communication session for logging-in to the applied work,
wherein the authentication server has a function
that creates two code Ci and Cj mutually different each other with overwhelming probability shown in [Mathematics 3],
[Mathematics 3]
Code Cj≠Code Cj (3)
that records either one of the codes Ci and Cj (Ci) of the [Mathematics 3] in the portable memory on the client segment, and records the other (Cj) in the memory on the service segment (2)
wherein the logging-in hands over the session ID to the portable memory, using a communication session independent of the communication session of the applied work,
under Dual Control of gathering together the transmission of Ci and Cj to the authentication server,
wherein the transmission of one (Ci) of the codes Ci or Cj recorded in the memory on the client segment (1) to the authentication server and the transmission of the other one (Cj) of the codes Ci or Cj recorded in the memory on the service segment (2) to the authentication server
the authentication server calculates such a probability that “two-parts-becomes-one” of the codes Ci and Cj,
when the probability=1.0, an authentication notice is returned to the client segment and the service segment,
when the probability<<1.0, an error notice is returned to both.
Note that the authentication server implements “Split Knowledge of a key” as follows; it has two one-way functions Y₁( ) and Y₂( ) and calculates the following [Mathematics 4] of an arbitrary key data K and sets the output value to the values of the passwords Ci and Cj of the [Mathematics 3];
[Mathematics 4]
Ci=Y₁(K) [4]
Cj=Y₂(K) [5]
And immediately after recording each of the codes Ci and Cj in the portable memory of the client segment (1) and the memory of the service segment (2), the key data K is deleted to make the key data K unavailable.
Note that the probability that “two-parts-become-one” of the codes Ci and Cj is the probability that the following [Mathematics 7] holds.
[Mathematics 7]
Y₁(Ci)^{-1=Y}₂⁻¹(Cj)=K

2. The two-parts-are-one password system using Split Knowledge and Dual Control of a key data according to claim 1 wherein;
the authentication server according to claim 1 comprising: <procedure to use a trapdoor of two one-way functions Y₁( ) and Y₂( ) according to [Mathematics 4] which can reproduce the key data K as described in claim 1,
Probability calculation means [Mathematics 7] calculating such probability that two-parts-become-one only when both codes Ci and Cj of [Mathematics 3] gather together,
[Mathematics 7]
Y₁⁻¹(Ci)=Y₂⁻¹(Cj)=K-->[Probability calculation that two-parts-become-one]
[Probability that two-parts-become-one]=1.0-->[Authentication notice]
[Probability that two-parts-become-one]<<1.0-->[Error notice]
in case [Probability that two-parts-become-one]=1.0 that satisfies Probability calculation means with probability=1.0, the authentication notice is returned to both a user side and the service server side, and
in case [Probability that two-parts-become-one]<<1.0, the error notice is returned to the both.
Note that the equation Y₁⁻¹(Ci)=Y₂⁻¹(Cj) in Probability calculation means of [Mathematics 7] shows the existence of a trapdoor of the two one-way functions Y₁( ) and Y₂( ).
